(19) United States
(12) Patent Application Publication
(10) Pub. No.: US 2026/0264217 A1
(43) Pub. Date: Sep. 10, 2026

(54) EXOSKELETON

(71) Applicant: AUXIVO AG, Schwerzenbach (CH)

(72) Inventors: Volker BARTENBACH, Uster (CH); Dario BEE, Wetzikon (CH); Melanie KOS, Effretikon (CH); Rachel VAN SLUIJS, Zürich (CH); Flavio MUELLER, Bern (CH)

(73) Assignee: AUXIVO AG, Schwerzenbach (CH)

(21) Appl. No.: 19/162,379

(22) PCT Filed: Mar. 4, 2024
(86) PCT No.: PCT/EP2024/055578

§ 371 Date: Sep. 4, 2025

(30) Foreign Application Priority Data
Mar. 6, 2023 (EP) 23160248.3

(51) Int. Cl. B25J 9/00

(52) U.S. Cl. CPC B25J 9/0006

(57) ABSTRACT

An exoskeleton for overhead, forward leaning or lifting activities includes: a shoulder exoskeleton for imposing a force or torque on an upper arm of a user, the shoulder exoskeleton comprising a vest arranged for being supported by an upper body of a user, preferably wherein the vest is adaptable to a width of the upper body, a first thigh cuff, and a first elastic back strap extending from the first thigh cuff to the vest. In a state of use, the upper body of the user supports the vest and a thigh of the user supports the first thigh cuff, and a first angle (α) is measured or defined between the upper body and the thigh.

The present invention relates to an exoskeleton for overhead, forward leaning or lifting activities. The invention can be used advantageously for lifting, lowering, holding, or moving (handling), the arm, a piece of luggage, a piece of furniture, construction material, construction components, tools, a larger or heavier assembly, boxes, parcels, bags, and/or other heavy loads.

An average human can lift and carry only a limited load for a limited time. The lifted load can impose mechanical stress on the muscles and tendons, the skeleton and its cartilages and joints. Repeated or prolonged lifting of loads can cause fatigue of muscles and/or wear of the joints. Further, the human needs to stabilise the lifted load by his arms, torso, shoulders, and spine. Particularly, the muscles can get tired when handling heavier loads in which tired state the joints are even more stressed.

WO 2020/234050 A1 discloses a body support device to support at least one part of the human body, comprising at least a first body fastening element fixable above a human's hip joint, at least a second body fastening element mechanically fixable below a human's hip joint and merely on the back side at least one elastic means, which mechanically connects the first body fastening element and the second body fastening element on the back side of the human body with each other, wherein the elastic means is adapted to be tensioned when a person mechanically linked to the body support device is bending down and to apply an erecting force to the person when the person (100) is bent down.

There is a need for an improved support system for overhead activities.

### Problem and Solution

It is an object to provide an improved support system for overhead activities.

This object is achieved by the exoskeleton according to claim 1 (first aspect of the invention). Preferred embodiments form the subject matter of the dependent claims.

The exoskeleton according to claim 1 is suitable for overhead, forward leaning or lifting activities. The exoskeleton comprises a shoulder exoskeleton for imposing a force or torque on an upper arm of a user. The shoulder exoskeleton comprises a vest arranged for being supported by an upper body of a user, preferably wherein the vest is adaptable to a width of the upper body. Further, the exoskeleton comprises a first thigh cuff, and a first elastic back strap extending from the first thigh cuff to the vest. In a state of use, the upper body of the user supports the vest and a thigh of the user supports the first thigh cuff, and a first angle is measured or defined between the upper body and the thigh. The first elastic back strap is arranged a) to stretch when the first angle decreases in the state of use, and b) to relax when the first angle increases in the state of use, particularly when the user is lifting a load from the ground or lowering the load to the ground or when the user is leaning forward.

In a state of use, a user is wearing the vest like a garment. So, when the user tries to perform overhead, forward leaning or lifting activities, the shoulder exoskeleton and/or the first elastic back strap can promote the user's activities. The shoulder exoskeleton can add to the shoulder's muscles such that the load imposes less stress on the muscles of the user. The vest can increase the contact area with the user's torso which can help to avoid an area of increased pressure on the user's torso. Further, the vest can make the shoulder exoskeleton more comfortable to wear and use. The first elastic back strap can support and/or reduce the strain on the user's back muscles and gluteus maximus, particularly when lifting repeatedly.

When the user leans forward or when the first angle between the upper body and the thigh is reduced, then the first elastic back strap is stretched, thereby storing energy elastically. When the user straightens or when the first angle is increased, then the first elastic back strap relaxes, thereby supporting the user's lifting work. The shoulder exoskeleton can impose a force or torque on an upper arm of a user, thereby also supporting the user's lifting work.

### PREFERRED EMBODIMENTS

Preferred embodiments explained in the following can be combined with each other, advantageously, unless stated otherwise.

In an embodiment the first elastic back strap comprises an elastic element, preferably wherein the ratio of a length of the first elastic back strap divided by a length of the elastic element is at least 3.

Preferably, the first elastic back strap comprises a rigid section mechanically connected with the elastic element, wherein the ratio of a spring constant [N/m] of the rigid section divided by a spring constant of the elastic element is at least 5.

Preferably, the elastic element is removable, particularly wherein the elastic element can be replaced by an elastic element of a different spring constant.

The vest of a further embodiment comprises an elastic fabric section arranged to abut on the user's back in use and arranged to adapt to the width of the user's upper body. Preferably, the elastic fabric section can comprise a mesh which may help to reduce a thermal resistance of the vest or to increase breathability.

The vest of another embodiment comprises a first shoulder strap, preferably wherein an end of the first elastic back strap extends to the first shoulder strap. Preferably, the vest comprises a chest strap arranged at a lower end of the vest and two shoulder straps each extending between an upper end of the vest and the chest strap. The chest strap can comprise a buckle or a hook-and-loop fastener. This embodiment may help to reduce a thermal resistance and/or to increase breathability.

An embodiment comprises a tensioning mechanism arranged for reversibly tensioning the first elastic back strap, preferably wherein the tensioning mechanism is supported by the first shoulder strap. The tensioning mechanism can comprise a strap and a buckle engaging the strap. The buckle may be mechanically connected to one of the shoulder straps. For tensioning, the user may pull a free end of the strap. The tensioning mechanism may be released by operating the buckle to release the strap.

The shoulder exoskeleton of an embodiment comprises a first arm strut, a first end of which is supported rotationally about an axis A by the first shoulder exo joint. The first arm strut can be extendable to increase the distance between its first and second ends, particularly by a telescopic mechanism. The first arm strut can comprise a piston guided inside a cylinder or another slide guide, for example a dovetail guide.

Another embodiment comprises a first back structure, wherein the first shoulder exo joint is supported by an end of the first back structure, wherein an opposite end of the first back structure can be supported by the vest. The first back structure can be bar-shaped. The first back structure can be made with aluminium, steel, magnesium, a polymer, PP, PE, ABS and/or a fibre reinforced polymer. The bar-shaped back structure can comprise a curved or angled section which extends over the user's shoulder in use. Another section of the back structure can abut on the user's back in use and/or can comprise a reinforcing rib.

A further embodiment comprises a first back structure, wherein the first shoulder exo joint is supported by an end of the first back structure, wherein an opposite end of the first back structure can be supported by a releasable hip belt of this embodiment. The first back structure can be bar-shaped. The first back structure can be made with aluminium, steel, magnesium, a polymer, PP, PE, ABS and/or a fibre reinforced polymer. The bar-shaped back structure can comprise a curved or angled section which extends over the user's shoulder in use. Another section of the back structure can abut on the user's back in use and/or can comprise a reinforcing rib. The releasable hip belt can comprise hip padding, a strap, a buckle preferably attached to the strap, and/or a second pocket arranged to accept the opposite end of the first back structure. The shoulder exoskeleton can comprise a second back structure, an end of which supporting a second shoulder exo joint. Thereby, a fraction of the load can be supported on the hips.

The first back structure of another embodiment comprises two ends, each arranged for supporting one such first shoulder exo joint. The first back structure can be made with aluminium, steel, magnesium, a polymer, PP, PE, ABS and/or a fibre reinforced polymer. The first back structure can be bar-shaped. The bar-shaped back structure can comprise two curved or angled sections each of which extends over one of the user's shoulders in use. Another section of the back structure can abut on the user's back in use and/or can comprise a reinforcing rib. An opposite end of the first back structure can be supported by the vest, preferably accepted in a first pocket of the vest. Alternatively, the opposite end of the first back structure can be supported by a releasable hip belt. The releasable hip belt can comprise hip padding, a strap preferably attached to the hip padding, a buckle preferably attached to the strap, and/or a second pocket for accepting the opposite end of the first back structure. The first back structure can comprise two of the opposite ends, and the releasable hip belt can comprise two of the second pockets each arranged for accepting one of the opposite ends of the first back structure. This may help to distribute the load more evenly to the user's body.

A further embodiment comprises a first biasing device arranged to impose a force or torque to the first arm strut to rotate about axis A, wherein at least a section of the first biasing device is supported by the first shoulder exo joint. Preferably, a first end of the first biasing device is mechanically connected with the first arm strut, and an opposite end of the first biasing device is mechanically connected with the first support plate.

Preferably, the biasing device comprises an elastic component which is arranged to relax while the user lifts the load. A first end of the elastic component is mechanically connected with the first arm strut, directly or indirectly, and an opposite end with the first shoulder exo joint, directly or indirectly. Alternatively or additionally, the biasing device can comprise an electric motor and/or a pneumatic cylinder.

In an embodiment, a first support plate of the first shoulder exo joint is supported rotationally about an axis B by the end of the first back structure. Axes A and B need not intersect. The first support plate may rotationally support an end of the first arm strut about axis A. The first support plate can have a first section arranged to provide the rotatability about axis A and a second section, preferable forming an angle with the first section, arranged to the rotatability about axis B

An embodiment comprises a releasable hip belt and a ribbon or loop attached to the hip belt, the ribbon being arranged to guide the first elastic back strap. Preferably, the hip belt comprises a mesh.

The first thigh cuff of another embodiment comprises an elastic section for adapting to a change of diameter of the user's thigh in use.

Another embodiment comprises a releasable securing mechanism connecting the vest and the first back structure. The securing mechanism comprises a strap and a buckle engaging the strap, which securing mechanism is for reducing relative movement of the first back structure relative to the vest. The buckle may be mechanically connected to one of the shoulder straps. An end of the strap can be connected with the first back structure and an opposite end of the strap can be connected with the vest. The strap may be fed through a slot in the first back structure. The buckle can be supported by the first back structure. For securing, the user may shorten the strap by moving the buckle. The securing mechanism may be released by operating the buckle.

A further embodiment comprises a second thigh cuff for supporting a second thigh of the user and a second elastic back strap extending from the second thigh cuff to the vest, preferably further comprising a second shoulder exo joint.

An embodiment comprises a second thigh cuff for supporting a second thigh of the user and a second elastic back strap extending from the second thigh cuff to the vest, preferably further comprising a second shoulder exo joint.

### Second Aspect of the Invention

The above object is also achieved by a shoulder exoskeleton (second aspect) which is suitable for overhead activities. The shoulder exoskeleton comprises a vest arranged for being supported by an upper body of a user, which vest is adaptable to a width of the upper body, a first shoulder exo joint supported by the vest, which first shoulder exo joint is arranged to be positioned adjacent or above a shoulder of the user in use, a first arm strut, a first end of which is supported rotationally about an axis A by the first shoulder exo joint, a first arm cuff supported by a second end of the first arm strut, the first arm cuff being arranged to support an upper arm of the user, a first biasing device arranged to impose a force or torque to the first arm strut to rotate about axis A. At least a section of the first biasing device is supported by the first shoulder exo joint or connected to the first shoulder exo joint.

In a state of use, a user is wearing the vest like a garment. Further, the first arm cuff is abutting on the triceps or is surrounding the upper arm. The first biasing device is arranged to impose a force or torque to the first arm strut to rotate about axis A. So, when the user tries to raise the arm, lift or hold a load, the biasing device can add to the shoulder's muscles such that the load imposes less stress on the muscles of the user. The vest can increase the contact area with the user's torso which can help to avoid an area of increased pressure on the user's torso. Further, the vest can make the shoulder exoskeleton more comfortable to wear and use.

Preferably, the exoskeleton according to the first aspect comprises the shoulder exoskeleton of the second aspect.

Preferably, the vest comprises a back section arranged to abut on the user's back in use.

In an embodiment, the vest comprises a buckle, a hook-and-loop fastener or a zip for closing the vest or its back section around the torso. The first arm cuff can comprise a hook, a buckle, or a hook-and-loop fastener for closing the first arm cuff around one of the user's upper arms.

The biasing device of a further embodiment comprises an elastic component which is arranged to relax while the user lifts the arm and/or load. Alternatively or additionally, the biasing device can comprise an electric motor, a pneumatic cylinder and/or a control system. A first end of the elastic component can be mechanically connected with the first arm strut, at least indirectly, and an opposite end can be mechanically connected with the first shoulder exo joint, at least indirectly. In another configuration, both ends of the elastic component are mechanically connected with the first support plate and the elastic component is looped around a cylinder extending from the first arm strut. Preferably, the biasing device can be adjusted to provide at least two levels of support, that is two different forces or torques to the first arm strut to rotate about axis A.

The vest of another embodiment comprises an elastic fabric section arranged to abut on the user's back is use and arranged to adapt to the width of the user's upper body. Preferably, the elastic fabric section can comprise a mesh which may help to reduce a thermal resistance of the vest or to increase breathability. The elastic fabric section can be a part of the vest's back section.

The first arm strut of a further embodiment is extendable to increase the distance between its first and second ends, particularly by a telescopic mechanism. The first arm strut can comprise a piston guided inside a cylinder or another slide guide, such as a prismatic guide or a dovetail guide.

Another embodiment comprises a first back structure, wherein the first shoulder exo joint is supported by an end of the first back structure, wherein an opposite end of the first back structure can be supported by the vest, particularly by the vest's back section. The first back structure can be bar-shaped. The first back structure can be made with aluminium, steel, magnesium, a polymer, PP, PE, ABS and/or a fibre reinforced polymer. The bar-shaped back structure can comprise a curved or angled section which extends over the user's shoulder in use. Another section of the back structure can abut on the user's back in use and/or can comprise a reinforcing rib.

Preferably, the vest comprises a first pocket arranged adjacent to the elastic fabric section and arranged for accepting the opposite end of the first back structure. The first pocket can be formed with a strip of fabric which is mechanically connected with the vest. The first pocket can be connected with the vest's back section.

A further embodiment comprises a first back structure, wherein the first shoulder exo joint is supported by an end of the first back structure, wherein an opposite end of the first back structure can be supported by a releasable hip belt of this embodiment. The first back structure can be bar-shaped. The first back structure can be made with aluminium, steel, magnesium, a polymer, PP, PE, ABS and/or a fibre reinforced polymer. The bar-shaped back structure can comprise a curved or angled section which extends over the user's shoulder in use. Another section of the back structure can abut on the user's back in use and/or can comprise a reinforcing rib. The releasable hip belt can comprise hip padding, a strap, a buckle preferably attached to the strap, and/or a second pocket arranged to accept the opposite end of the first back structure. The shoulder exoskeleton can comprise a second back structure, an end of which supporting a second shoulder exo joint. Thereby, a fraction of the load can be supported on the hips.

The first back structure of another embodiment comprises two ends, each arranged for supporting one such first shoulder exo joint. The first back structure can be made with aluminium, steel, magnesium, a polymer, PP, PE, ABS and/or a fibre reinforced polymer. The first back structure can be bar-shaped. The bar-shaped back structure can comprise two curved or angled sections each of which extends over one of the user's shoulders in use. Another section of the back structure can abut on the user's back in use and/or can comprise a reinforcing rib. An opposite end of the first back structure can be supported by the vest, preferably accepted in a first pocket of the vest. Alternatively, the opposite end of the first back structure can be supported by a releasable hip belt. The releasable hip belt can comprise hip padding, a strap preferably attached to the hip padding, a buckle preferably attached to the strap, and/or a second pocket for accepting the opposite end of the first back structure. The first back structure can comprise two of the opposite ends, and the releasable hip belt can comprise two of the second pockets each arranged for accepting one of the opposite ends of the first back structure. This may help to distribute the load more evenly to the user's body.

The shoulder exo joint of an embodiment comprises a first support plate which is supported rotationally about an axis B by the end of the first back structure. Axes A and B need not intersect. The first support plate may rotationally support an end of the first arm strut about axis A. The first support plate can have a first section arranged to provide the rotatability about axis A and a second section, preferable forming an angle with the first section, arranged to the rotatability about axis B. The first support plate can be made with aluminium, steel, magnesium, a polymer, PP, PE, ABS and/or a fibre reinforced polymer.

The first biasing device of another embodiment comprises elastic component which may be an elastic band. Preferably, the elastic component is guided by a first wheel supported by the first support plate or by cylinder extending from the first support plate.

In another configuration, both ends of the elastic component are mechanically connected with the first support plate and the elastic component is looped around a cylinder extending from the first arm strut. Preferably, the cylinder is guided by the first arm strut to be positioned along the first arm strut (movable cylinder mechanism), whereby a distance between the cylinder and axis A can be increased or decreased. This movable cylinder mechanism serves to adjust the tensioning of the elastic component and can help to adjust the torque about axis A imposed by the biasing device on the first arm strut.

In another configuration, a first end of the first biasing device or elastic component is mechanically connected with the first arm strut, particularly with the cylinder extending from the first arm strut, and an opposite end of the first biasing device is mechanically connected with the first support plate. Preferably, the cylinder is guided by the first arm strut to be positioned along the first arm strut (movable cylinder mechanism), whereby a distance between the cylinder and axis A can be increased or decreased. This movable cylinder mechanism serves to adjust the tensioning of the elastic component and can help to adjust the torque about axis A imposed by the biasing device on the first arm strut.

A further embodiment comprises a mechanical switch which is supported by the first support plate and is arranged to change a pretension of the first biasing device. An end of the first biasing device or elastic component may be mechanically connected with the mechanical switch and the opposite end with the first arm strut. An end of the mechanical switch may be supported rotationally by the first support plate and may be operable like a lever. The mechanical switch may be arranged to be reversibly transferred from a first state in which the pretension of the first biasing device is smaller (low pretension state) to a second state in which the pretension of the first biasing device is greater (high pretension state). If the first biasing member comprises an elastic component, preferably an end of the elastic component is mechanically connected with the first support plate, the opposite end of the elastic component is mechanically connected with the mechanical switch, and the elastic component is looped around a cylinder extending from the first arm strut.

In a further configuration, an end of the first biasing device or elastic component may be mechanically connected with the mechanical switch and the opposite end with the first arm strut, particularly with a cylinder extending from the first arm strut. Preferably, the cylinder is guided by the first arm strut to be positioned along the first arm strut (movable cylinder mechanism), whereby a distance between the cylinder and axis A can be increased or decreased. This movable cylinder mechanism serves to adjust the tensioning of the elastic component and can help to adjust the torque about axis A imposed by the biasing device on the first arm strut.

Another embodiment comprises a first locking mechanism arranged to prevent the first support plate to rotate about axis B. This may help to avoid an unintended rotation, particularly when the shoulder exoskeleton is not in use.

In a further embodiment, the vest comprises a chest strap arranged at a lower end of the vest and two shoulder straps each extending between an upper end of the vest and the chest strap. The chest strap can comprise a buckle or a hook-and-loop fastener. This embodiment may help to reduce a thermal resistance and/or to increase breathability, improve fixation on the user's torso, improve comfort by distributing the pressure more equally, and allows size adjustment. The chest strap and/or the shoulder strap can extend from the vest's back section.

Preferably, the vest comprises a removable chest padding element. The chest padding element can be positioned between the chest strap and the torso during use and can increase the comfort of the vest. The chest padding element can be mechanically connected to the chest strap, particularly by a loop arranged to accept the chest strap.

The vest of another embodiment comprises two or more layers of foam or foam mats (sandwich foam structure), which layers or mats are arranged adjacent to the elastic fabric section. A first of these foam layers may be thicker and/or softer, than the second foam layer. The sandwich foam structure may help to increase the structural stiffness of the vest, cushioning and/or comfort. Preferably, a section of the vest comprising the first pocket can be reinforced by the two or more layers of foam or foam mats.

In a further embodiment an outer layer of the vest comprises a mesh, particularly for increasing ventilation, preferably a stiff mesh for reinforcing the vest. Preferably, the chest strap and/or the shoulder straps comprise a mesh. Preferably, an outer layer of the vest comprises a mesh. Preferably, a section of the vest to which the first pocket is connected comprises a mesh.

According to an embodiment, the vest and the first back structure are connected by a releasable securing mechanism comprising a strap and a buckle engaging the strap. The buckle may be mechanically connected to one of the shoulder straps. An end of the strap can be connected with the first back structure and an opposite end of the strap can be connected with the vest. The strap may be fed through a slot in the first back structure. The buckle can be supported by the first back structure. The securing mechanism may help to reduce relative motion of the first back structure relative to the vest. For securing the first back structure to the vest, the user may shorten the strap by moving the buckle. The securing mechanism may be released by operating the buckle.

An embodiment comprises a second shoulder exo joint supported by the vest, which second shoulder exo joint is arranged to be positioned adjacent or above another shoulder of the user in use, the second shoulder exo joint being similar to the first shoulder exo joint, a second arm strut, a first end of which is supported rotationally by the second shoulder exo joint, the second arm strut being similar to the first arm strut, a second arm cuff supported by a second end of the second arm strut and arranged to support another upper arm of the user, the second arm cuff being similar to the first arm cuff, a second biasing device arranged for imposing a torque on the second arm strut urging the second arm strut to rotate relative to the second shoulder exo joint, wherein at least a section of the second biasing device is supported by the second shoulder exo joint, the second biasing device being similar to the first biasing device.

Preferably, the shoulder exo skeleton comprises a second back structure similar to the first back structure, the vest further comprising another pocket similar to the first pocket arranged for accepting an opposite end of the second back structure.

### EXEMPLARY EMBODIMENTS

Further advantages become apparent to the skilled person from the following explanations relating to the figures which show exemplary embodiments.

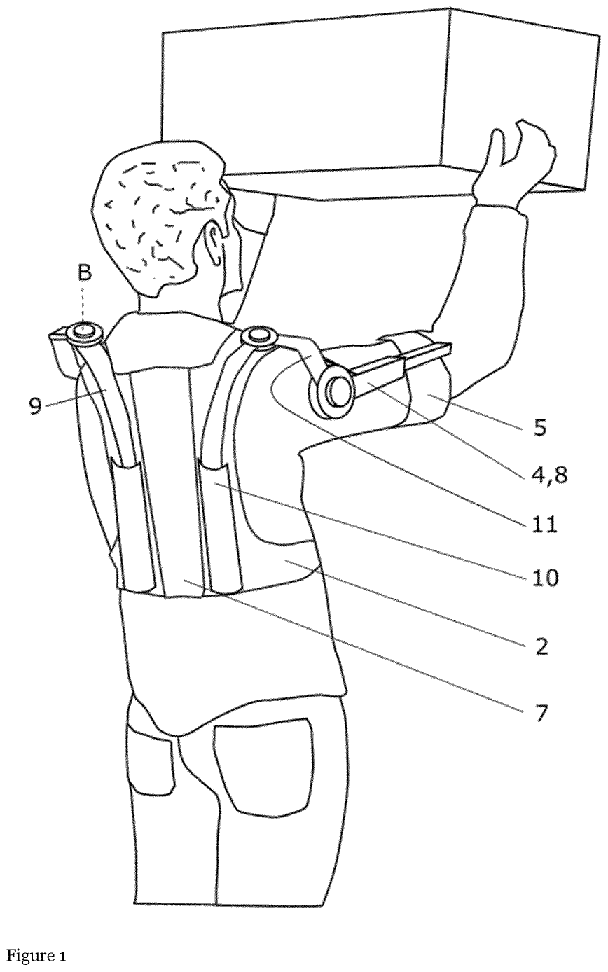

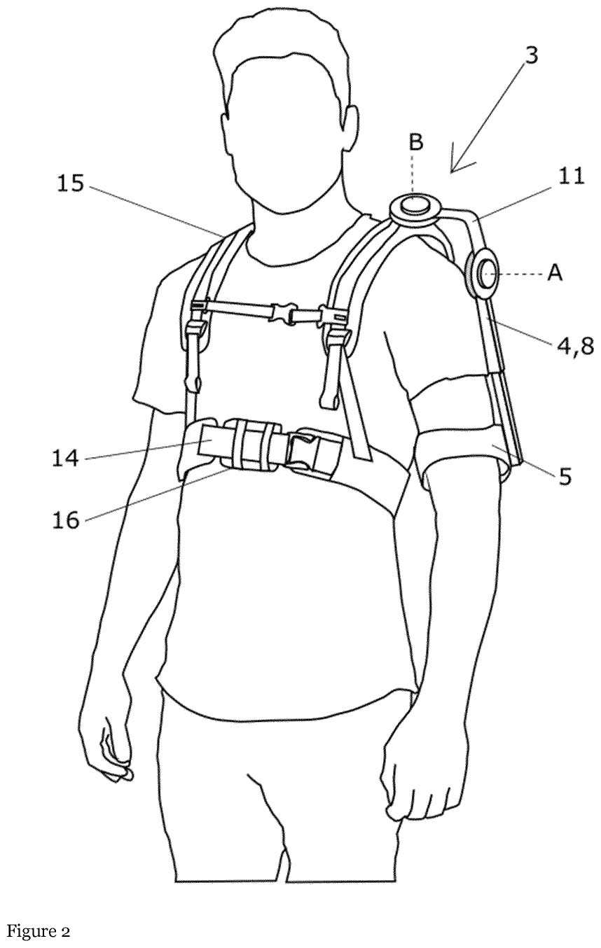

FIG. 1 schematically shows an exemplary shoulder exoskeleton 1 in its state of use.

The shoulder exoskeleton comprises a vest 2 arranged for being supported by an upper body of a user, which vest is adaptable to a width of the upper body. The shoulder exoskeleton comprises a first shoulder exo joint 3 supported by the vest, which first shoulder exo joint is arranged to be positioned adjacent or above a shoulder of the user in use, a first arm strut 4, a first end of which is supported rotationally about an axis A by the first shoulder exo joint, a first arm cuff 5 supported by a second end of the first arm strut, the first arm cuff being arranged to support an upper arm of the user, and a first biasing device 6 (not shown) arranged to impose a force or torque to the first arm strut to rotate about axis A. At least a section or end of the first biasing device is connected to the first shoulder exo joint.

In the state of use, a user is wearing the vest 2 like a garment. Further, the first arm cuff 5 is abutting on the triceps or is surrounding the upper arm. The exemplary shoulder exoskeleton comprises a second shoulder exo joint 3a supported by the vest, a second arm strut 4a, a second arm cuff 5a, and a second biasing device 6a which are similar to the respective first member. The user is lifting a box and the biasing devices help to relieve the shoulder's muscles.

The vest comprises an elastic fabric section 7 which abuts on the user's back in use and is arranged to adapt to the width of the user's upper body. The arm struts are extendable to increase the distance between its first and second end and comprise a telescopic mechanism 8, here a prismatic guide. The shoulder exoskeleton comprises two back structures 9, 9a which are curved or angled. An end of each of the back structures is accepted in a respective pocket 10, 10a of the vest. Preferably, a section of the vest comprising the first pocket can be reinforced by the two or more layers of foam or foam mats. The opposite end of each of the back structures is arranged above one of the user's shoulders. The elastic fabric section is arranged between the pockets 10, 10a.

An opposite end of each of the back structures supports one of the shoulder exo joints. Each of the shoulder exo joints comprises a support plate 11, 11a, and each of the support plates is supported rotationally about axis B by one of the back structures 9, 9a. The vest comprises a chest strap 14 at its lower end and two shoulder straps 15, 15a each extending between an upper end of the vest and the chest strap.

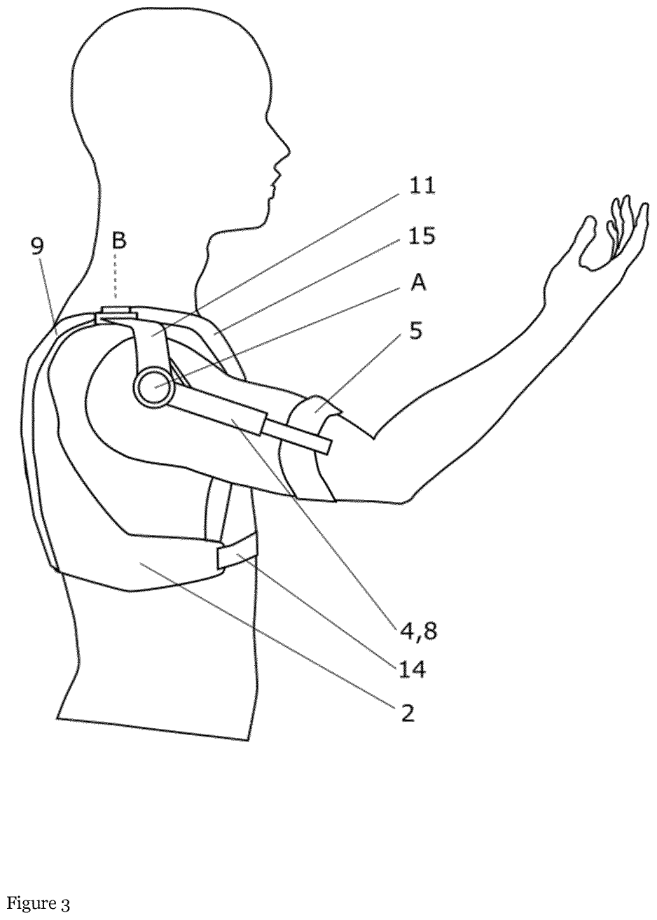

FIG. 2 schematically shows the shoulder exoskeleton of FIG. 1 from a different perspective. A removable chest padding element 16, is attached to the chest strap 14 and are arranged between the chest strap and the user's torso. The chest strap has a buckle or a hook-and-loop fastener which allows to close the chest strap around the torso conveniently. Two releasable tensioning mechanisms connecting the vest with one of the back structures are not shown.

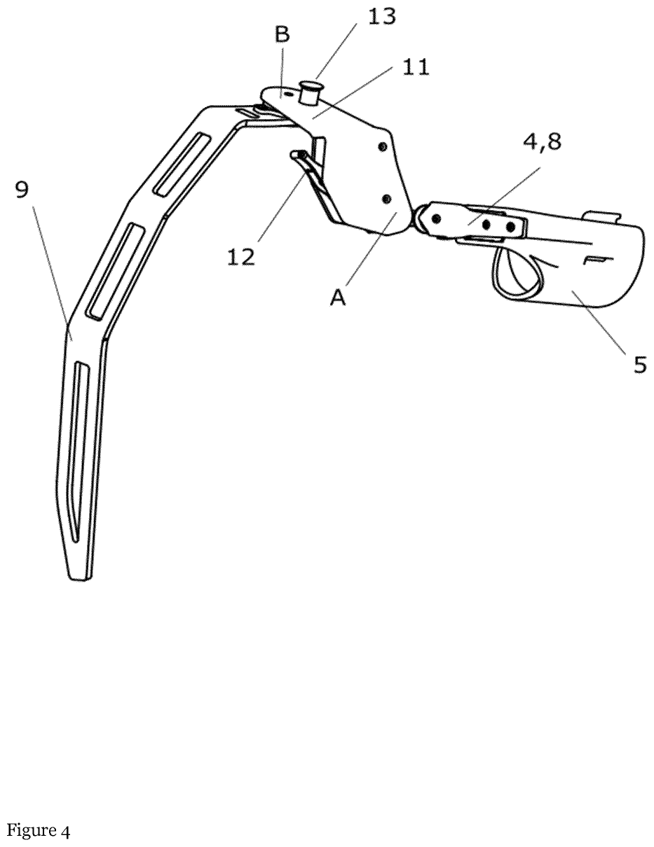

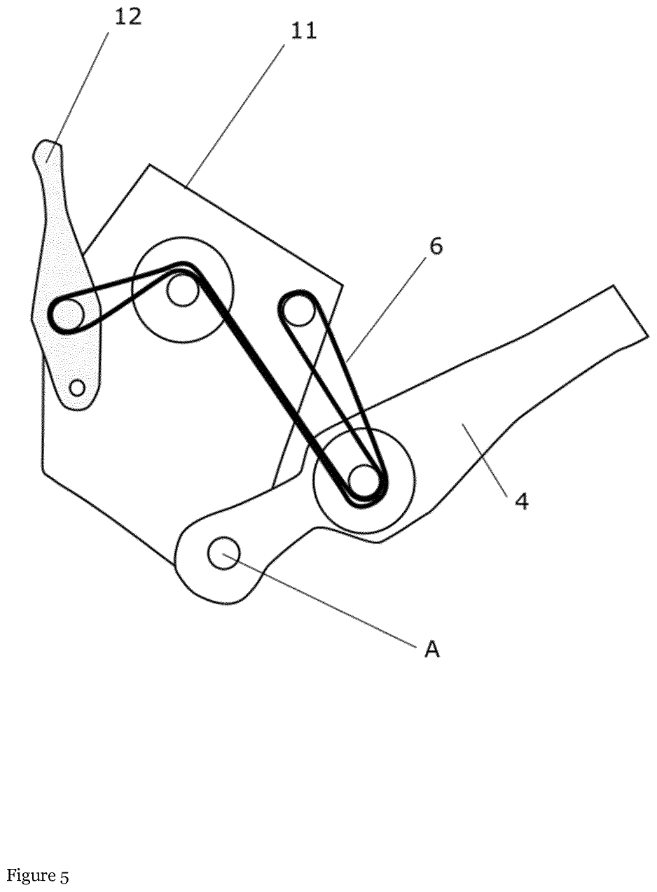

FIG. 3 schematically shows the shoulder exoskeleton of FIGS. 1 and 2 from a different angle and the respective explanations apply. A section of the vest, an outer layer of the vest, one of the shoulder straps and/or the chest strap can comprise a mesh.

The exemplary shoulder exoskeleton 1 can comprise a releasable securing mechanism 19 (not shown) connecting the vest 2 and one of the back structures 9, 9a. The securing mechanism comprises a strap and a buckle engaging the strap, which securing mechanism is for reducing relative movement of the first back structure relative to the vest. The buckle may be mechanically connected to one of the shoulder straps 15, 15a. An end of the strap can be connected with the back structure 9, 9a and an opposite end of the strap can be connected with the vest 2. The strap may be fed through a slot in the back structure 9, 9a. The buckle can be supported by respective the back structure 9, 9a. For securing, the user may shorten the strap by moving the buckle. The securing mechanism may be released by operating the buckle.

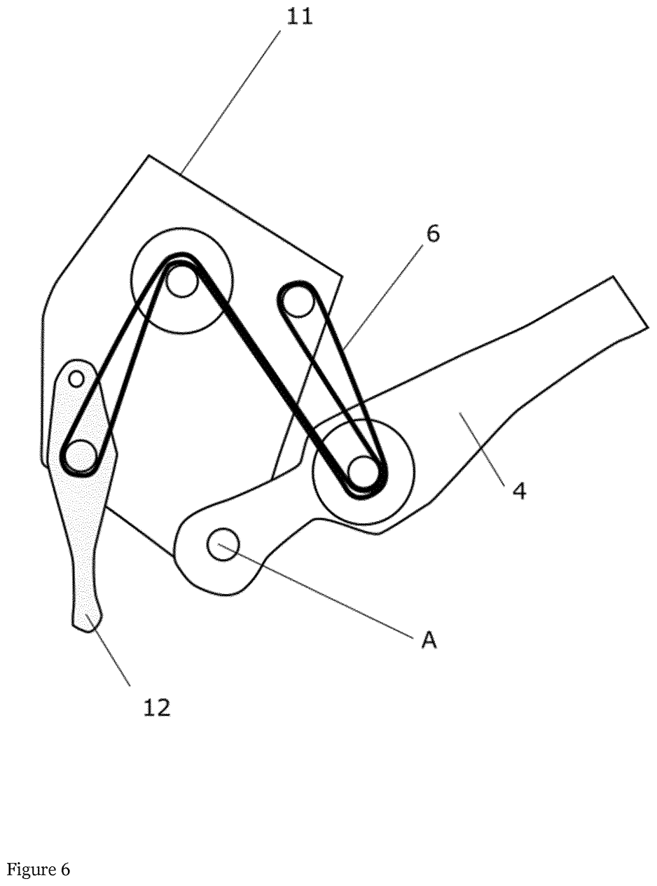

FIG. 4 schematically shows an assembly of the exemplary shoulder exoskeleton. The assembly comprises one of the back structures 9, one of the support plates 11 supported rotationally about axis B by the back structure, and one of the arm struts 4 an end of which is supported rotationally about axis A by the support plate. The arm strut 4 comprises the telescopic mechanism 8. One of the arm cuffs 5 is connected with an opposite end of the arm strut 4. An end of the biasing device 6 concealed by the support plate 11 is connected mechanically with the arm strut. The opposite end of the biasing device may be connected with the support plate. The mechanical switch 12 rotationally supported by the support plate 11 is not compulsory, but the opposite end of the biasing device is connected with the mechanical switch as is explained below. The locking mechanism 13 to prevent the first support plate to rotate relative to the back structure about axis B is not compulsory.

The function of mechanical switch 12 is shown in FIGS. 5 and 6. The mechanical switch serves to change the pre-tension of the elastic component of the biasing device 6. An end of the elastic component is mechanically connected with the first support plate 11, the opposite end of the elastic component is mechanically connected with the mechanical switch, and the elastic component is looped around a cylinder extending from the first arm strut 4. The low pretension state is shown in FIG. 5 and the high pretension state in FIG. 6. By operating the mechanical switch, the pre-tension of the elastic component of the biasing device can be changed.

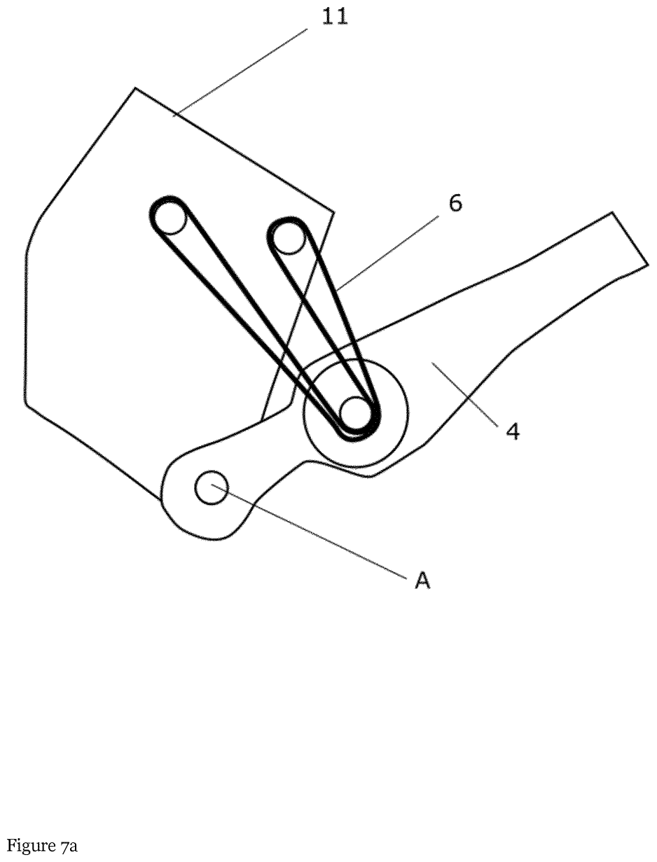

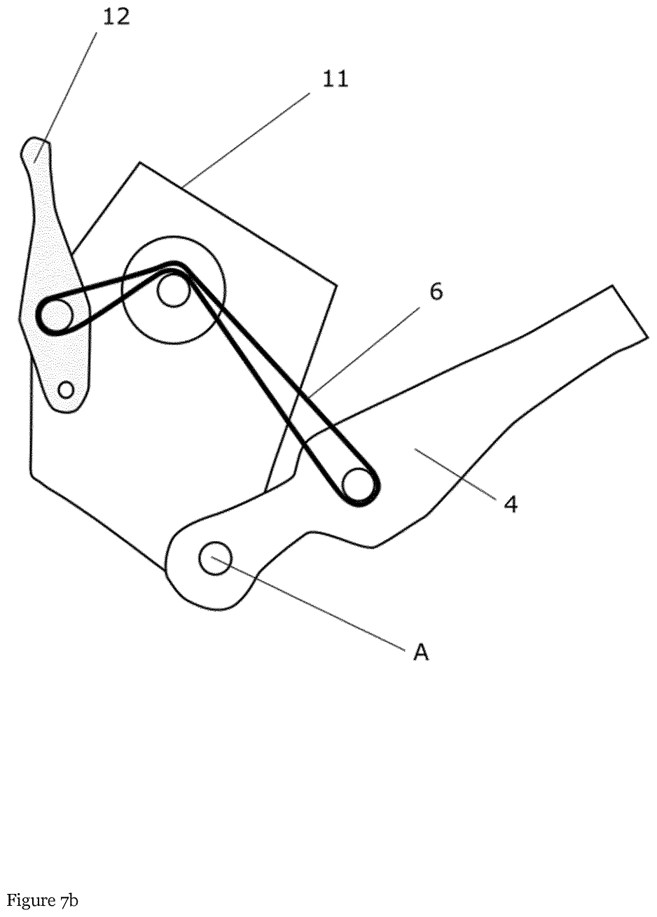

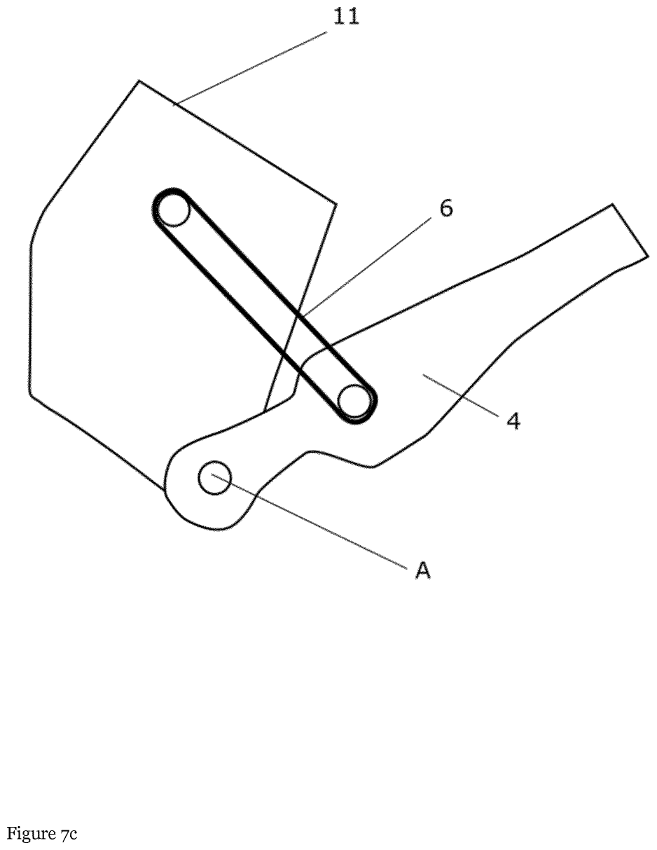

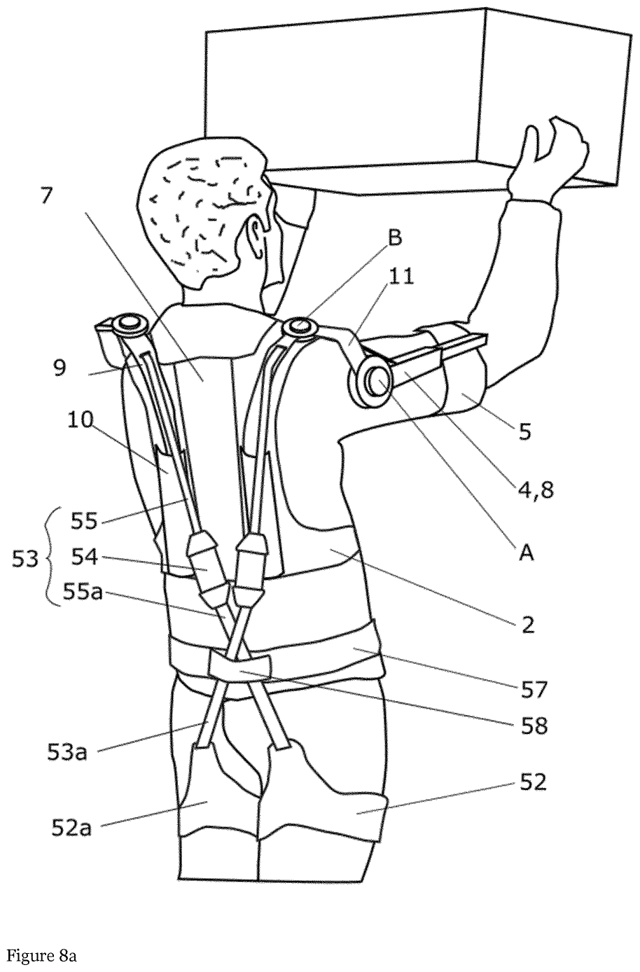

FIGS. 7a to 7c show different arrangements of the biasing device 6 comprising the elastic component. Both ends of the elastic component are attached to the support plate 11 and the elastic component is looped around a cylinder extending from the first arm strut 4 in FIG. 7a. FIG. 7b shows that an end of the elastic component is mechanically connected with the first arm strut 4, the opposite end is connected to the mechanical switch 12 hinged on the support plate 11, and the elastic component is looped around a cylinder extending from support plate 11. In FIG. 7c, an end of the elastic component is mechanically connected with the first arm strut 4 and the opposite end is mechanically connected with the support plate 11.

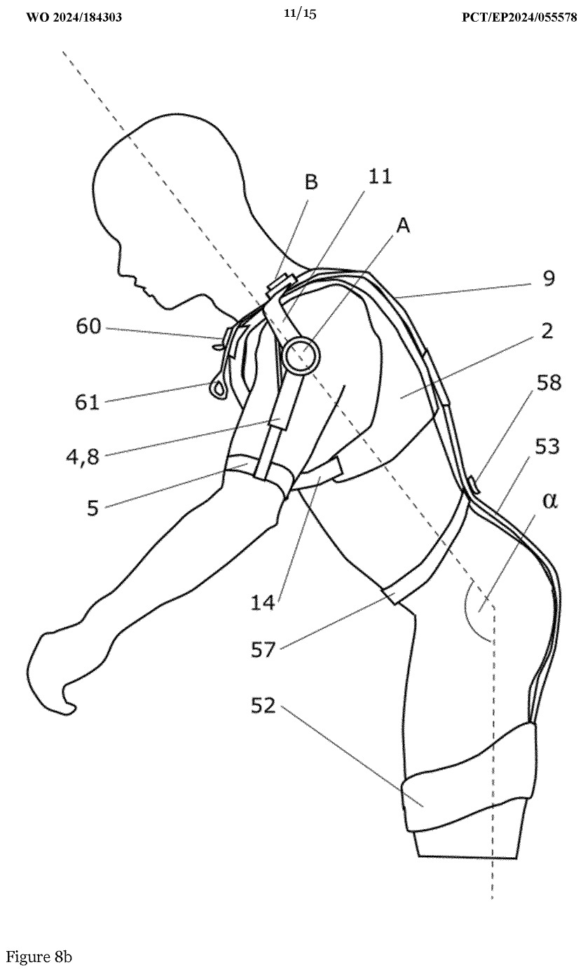

FIG. 8 schematically shows an exemplary exoskeleton 51 for overhead, forward leaning or lifting activities in its state of use. FIG. 8a shows the exemplary exoskeleton in a perspective view and FIG. 8b from a side. In FIG. 8b, the user is leaning forward such that the first angle α measured or defined between the upper body and the thigh is less than 180°.

The exemplary exoskeleton 51 for overhead, forward leaning or lifting activities (see FIG. 8a) comprises a shoulder exoskeleton 1 for imposing a force or torque on an upper arm of a user, the shoulder exoskeleton comprising a vest 2 arranged for being supported by an upper body of a user, preferably wherein the vest is adaptable to a width of the upper body, a first thigh cuff 52, and a first elastic back strap 53 extending from the first thigh cuff to the vest. In a state of use, the upper body of the user supports the vest, a thigh of the user supports the first thigh cuff, and a first angle is measured or defined between the upper body and the thigh. The first elastic back strap is arranged a) to stretch when the first angle decreases in the state of use, and b) to relax when the first angle increases in the state of use, particularly when the user is lifting a load from the ground or lowering the load to the ground or when the user is leaning forward.

The vest comprises a chest strap 14 and two shoulder straps 15, 15a which extend from the chest strap to an upper end of the vest. The exoskeleton comprises a hip belt 57 to which a ribbon or loop 58 is attached. The ribbon guides the elastic back straps 53.

The exoskeleton comprises a second thigh cuff 52a, a second elastic back strap 53a extending from the second thigh cuff to the vest and two tensioning mechanisms 56, 56a (not shown in FIG. 8a) for reversibly tensioning the respective elastic back strap. The buckle 60 engages with the strap 61 of the tensioning mechanism (see FIG. 8b).

Elastic elements 54, 54a of the elastic back straps 53, 53a can be replaced by elastic elements of a different spring constant [N/m] to adapt for a different load. Rigid sections 55, 55a of the elastic back straps 53, 53a attach the elastic elements to the vest and to the respective thigh cuff 52, 52a.

The shoulder exoskeleton 1 comprises a first shoulder exo joint 3 supported by the vest, which first shoulder exo joint is arranged to be positioned adjacent or above a shoulder of the user in use, a first arm strut 4, a first end of which is supported rotationally about an axis A by the first shoulder exo joint, a first arm cuff 5 supported by a second end of the first arm strut, the first arm cuff being arranged to support an upper arm of the user, and a first biasing device 6 (not shown) arranged to impose a force or torque to the first arm strut to rotate about axis A. At least a section or end of the first biasing device is connected to the first shoulder exo joint.

In the state of use, a user is wearing the vest 2 like a garment. Further, the first arm cuff 5 is abutting on the triceps or is surrounding the upper arm. The exemplary shoulder exoskeleton comprises a second shoulder exo joint 3a supported by the vest, a second arm strut 4a, a second arm cuff 5a, and a second biasing device 6a which are similar to the respective first member. The user is lifting a box and the biasing devices help to relieve the shoulder's muscles.

The vest comprises an elastic fabric section 7 which abuts on the user's back in use and is arranged to adapt to the width of the user's upper body. The arm struts are extendable to increase the distance between its first and second end and comprise a telescopic mechanism 8, here a prismatic guide. The shoulder exoskeleton comprises two back structures 9, 9a which are curved. An end of each of the back structures is accepted in a respective pocket 10, 10a of the vest. Preferably, a section of the vest comprising the first pocket can be reinforced by the two or more layers of foam or foam mats. An end of each of the back structures is arranged above one of the user's shoulders. The elastic fabric section is arranged between the pockets 10, 10a.

An end of each of the back structures supports one of the shoulder exo joints. Each of the shoulder exo joints comprises a support plate 11, 11a, and each of the support plates is supported rotationally about axis B by one of the back structures 9, 9a. The vest comprises a chest strap 14 at its lower end and two shoulder straps 15, 15a each extending between an upper end of the vest and the chest strap. A section of the vest, an outer layer of the vest, one of the shoulder straps and/or the chest strap can comprise a mesh.

The shoulder exoskeleton 1 of the exemplary exoskeleton can comprise a releasable securing mechanism 19 (not shown) connecting the vest 2 and one of the back structures 9, 9a. The securing mechanism comprises a strap and a buckle engaging the strap, which securing mechanism is for reducing relative movement of the first back structure relative to the vest. The buckle may be mechanically connected to one of the shoulder straps 15, 15a. An end of the strap can be connected with the back structure 9, 9a and an opposite end of the strap can be connected with the vest 2. The strap may be fed through a slot in the back structure 9, 9a. The buckle can be supported by respective the back structure 9, 9a. For securing, the user may shorten the strap by moving the buckle. The securing mechanism may be released by operating the buckle.

FIG. 8b shows the same exoskeleton from a side. Apparently, the user is leaning forward such that the first angle α is less than 180°. The explanations concerning FIG. 8a apply. Preferably, the exoskeleton comprises the above exemplary shoulder exoskeleton.

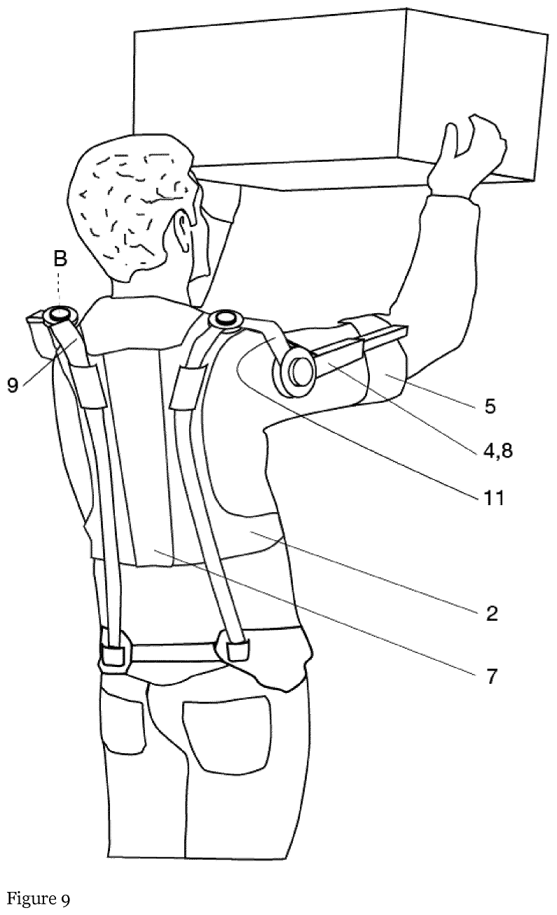

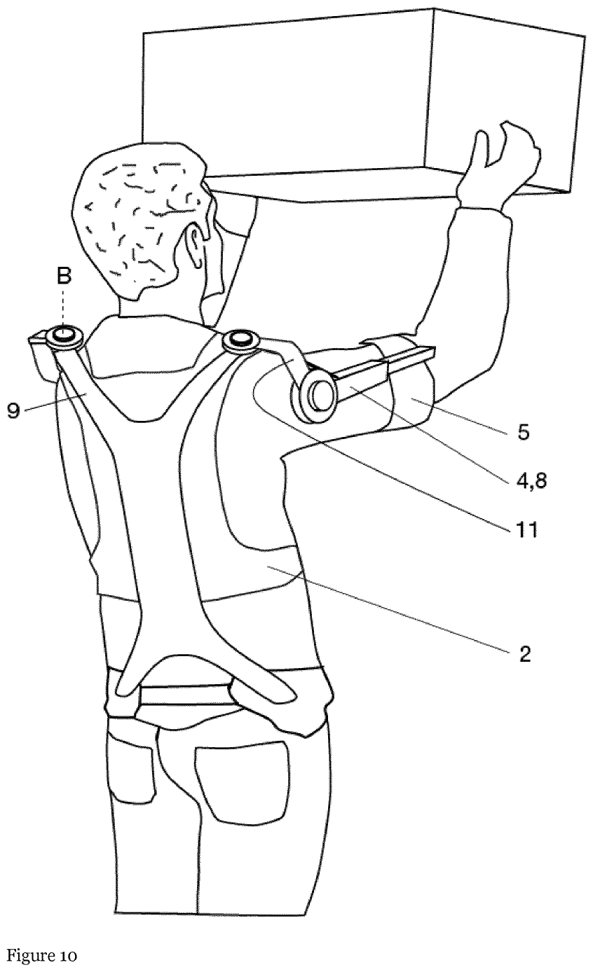

FIG. 9 shows another example of the exoskeleton. The shoulder exoskeleton comprises a vest 2 arranged for being supported by an upper body of a user, which vest is adaptable to a width of the upper body. The shoulder exoskeleton comprises a first shoulder exo joint 3 supported by the vest, which first shoulder exo joint is arranged to be positioned adjacent or above a shoulder of the user in use, a first arm strut 4, a first end of which is supported rotationally about an axis A by the first shoulder exo joint, a first arm cuff 5 supported by a second end of the first arm strut, the first arm cuff being arranged to support an upper arm of the user, and a first biasing device 6 (not shown) arranged to impose a force or torque to the first arm strut to rotate about axis A. At least a section or end of the first biasing device is connected to the first shoulder exo joint.

In the state of use, a user is wearing the vest 2 like a garment. The vest comprises an elastic fabric section 7 which abuts on the user's back in use and is arranged to adapt to the width of the user's upper body. The vest comprises a chest strap 14 at its lower end and two shoulder straps 15, 15a each extending between an upper end of the vest and the chest strap. Preferably, a section of the vest can be reinforced by the two or more layers of foam or foam mats. Further, the first arm cuff 5 is abutting on the triceps or is surrounding the upper arm.

The exemplary shoulder exoskeleton comprises a second shoulder exo joint 3a supported by the vest, a second arm strut 4a, a second arm cuff 5a, and a second biasing device 6a which are similar to the respective first member. The arm struts are extendable to increase the distance between its first and second end and comprise a telescopic mechanism 8, here a prismatic guide. The user is lifting a box and the biasing devices help to relieve the shoulder's muscles.

The shoulder exoskeleton comprises two back structures 9, 9a which are curved or angled. Further, the shoulder exoskeleton includes a hip belt 20 which comprises hip padding, a strap, a buckle preferably attached to the strap, and two second pockets supporting or accepting the opposite ends of the first and second back structures. An end of each of the back structures is arranged above one of the user's shoulders and supports one of the shoulder exo joints. Each of the shoulder exo joints comprises a support plate 11, 11a, and each of the support plates is supported rotationally about axis B by one of the back structures 9, 9a.

FIG. 10 shows a modification of the exemplary embodiment of FIG. 9. This modified shoulder exoskeleton includes a particular first back structure 9 comprising two ends each arranged above one of the user's shoulders and each supporting one of the shoulder exo joints 3, 3a. The particular first back structure also comprises two opposite ends each of which is supported by or accepted in the second pockets 21 of the releasable hip belt 20.

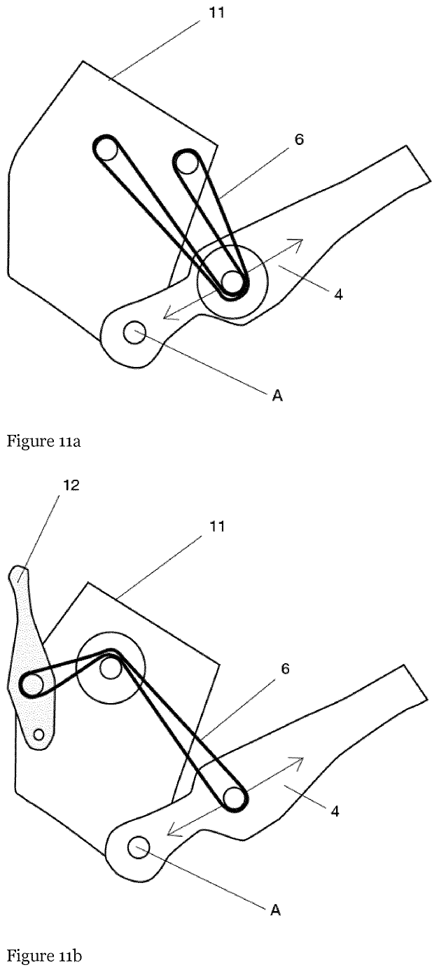

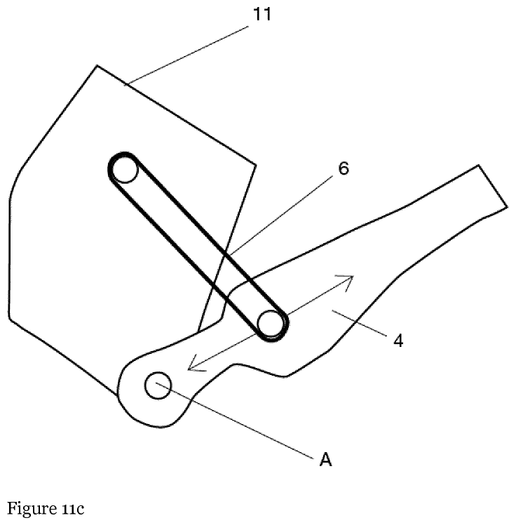

FIG. 11 shows variants of the biasing devices of FIGS. 5 to 7. The biasing device of FIG. 11a resembles that of FIG. 7a. Referring to FIG. 11a, the cylinder, around which the elastic component of the biasing device is looped, is guided to be positioned along the first arm strut 4, whereby a distance between the cylinder and axis A can be increased or decreased. Thereby, the torque about axis A imposed by the biasing device on the first arm strut can be adjusted.

The biasing device of FIG. 11b resembling that of FIG. 7b comprises an elastic component, an end of which is looped around a cylinder extending from the first arm strut 4. The opposite end of the elastic component is connected with the mechanical switch 12 just as in FIG. 7b. The cylinder is guided by the first arm strut to be positioned along the first arm strut 4, for increasing or decreasing a distance between the cylinder and axis A. This mechanism to adjust the tensioning of the biasing device can help to adjust the torque about axis A imposed by the biasing device on the first arm strut.

FIG. 11c shows another biasing device resembling FIG. 7c. An end of the elastic component 6 is looped around a cylinder extending from the first arm strut 4. The opposite end of the elastic component is connected with the support plate 11. The cylinder is guided by the first arm strut to be positioned along the first arm strut 4 to increase or decrease a distance between the cylinder and axis A. Changing this distance can help to set the torque about axis A imposed by the biasing device on the first arm strut.

### REFERENCE SIGNS

1 shoulder exoskeleton
2 vest
3, 3a shoulder exo joint
4, 4a arm strut
5, 5a arm cuff
6, 6a biasing device
7 elastic fabric section
8 telescopic mechanism of arm strut
9, 9a back structure
10, 10a first pocket for accepting an end of the back structure
11, 11a support plate of shoulder exo joint
12 mechanical switch
13 locking mechanism
14 chest strap
15, 15a shoulder strap
16 chest padding element
17 sandwich foam structure
18 mesh
19 securing mechanism
20 releasable hip belt
21 second pocket of hip belt for accepting an end of the back structure
51 Exoskeleton
52, 52a thigh cuff
53, 53a elastic back strap
54, 54a elastic element
55, 55a rigid section of elastic back strap
56, 56a tensioning mechanism
57 hip belt
58 ribbon or loop
59, 59a elastic section of thigh cuff
60 buckle of tensioning mechanism
61 strap of tensioning mechanism
α First angle
A first axis
B second axis

1. Exoskeleton for overhead, forward leaning or lifting activities, comprising
a shoulder exoskeleton for imposing a force or torque on an upper arm of a user, the shoulder exoskeleton comprising a vest arranged for being supported by an upper body of a user, preferably wherein the vest is adaptable to a width of the upper body,
a first thigh cuff, and
a first elastic back strap extending from the first thigh cuff to the vest,
wherein, in a state of use, the upper body of the user supports the vest and a thigh of the user supports the first thigh cuff, and a first angle (α) is measured or defined between the upper body and the thigh,
wherein the first elastic back strap is arranged a) to stretch when the first angle decreases in the state of use, and b) to relax when the first angle increases in the state of use, particularly when the user is lifting a load from the ground or lowering the load to the ground or when the user is leaning forward.

2. Exoskeleton according to claim 1, wherein the first elastic back strap comprises an elastic element, preferably wherein the ratio of a length of the first elastic back strap divided by a length of the elastic element is at least 3.

3. Exoskeleton according to claim 2, wherein the first elastic back strap comprises a rigid section mechanically connected with the elastic element, wherein the ratio of a spring constant [N/m] of the rigid section divided by a spring constant of the elastic element is at least 5.

4. Exoskeleton according to claim 2, wherein the elastic element is removable, particularly wherein the elastic element can be replaced by an elastic element of a different spring constant.

5. Exoskeleton according to claim 1, wherein the vest comprises an elastic fabric section arranged to abut on the user's back in use and arranged to adapt to the width of the user's upper body.

6. Exoskeleton according to claim 1, wherein the vest comprises a first shoulder strap, preferably wherein an end of the first elastic back strap extends to the first shoulder strap.

7. Exoskeleton according to claim 1, further comprising a tensioning mechanism arranged for reversibly tensioning the first elastic back strap, preferably wherein the tensioning mechanism is supported by the first shoulder strap.

8. Exoskeleton according to claim 1, wherein the shoulder exoskeleton comprises a first shoulder exo joint supported by the vest, which first shoulder exo joint is arranged to be positioned adjacent or above a shoulder of the user in use.

9. Exoskeleton according to claim 8, wherein the shoulder exoskeleton comprises a first arm strut, a first end of which is supported rotationally about an axis A by the first shoulder exo joint, preferably wherein the first arm strut comprises a telescopic mechanism.

10. Exoskeleton according to claim 8, further comprising a first back structure, wherein the first shoulder exo joint is supported by an end of the first back structure, preferably wherein an opposite end of the first back structure is supported by the vest, preferably wherein the vest comprises a first pocket arranged adjacent to the elastic fabric section and arranged for accepting the opposite end of the first back structure.

11. Exoskeleton according to claim 9, further comprising a first biasing device arranged to impose a force or torque to the first arm strut to rotate about axis A, wherein at least a section of the first biasing device is supported by the first shoulder exo joint.

12. Exoskeleton according to claim 10, wherein a first support plate of the first shoulder exo joint is supported rotationally about an axis B by the end of the first back structure.

13. Exoskeleton according to claim 9, wherein the first biasing device is connected with the first support plate and with the first arm strut, preferably the first biasing device is looped around a cylinder extending from the first arm strut, preferably wherein the cylinder is guided by the first arm strut such that a distance between the cylinder and axis A can be increased or decreased.

14. Exoskeleton according to claim 1, wherein the first thigh cuff comprises an elastic section for adapting to a change of diameter of the user's thigh in use.

15. Exoskeleton according to claim 10, wherein the vest and the first back structure are connected by a releasable securing mechanism comprising a strap and a buckle engaging the strap, which securing mechanism for reducing relative movement of the first back structure relative to the vest.
